(19) United States
(12) Patent Application Publication
(10) Pub. No.: US 2009/0013280 A1
(43) Pub. Date: Jan. 8, 2009

(54) Graphical user interface with meta-information and meta-control for items in a list

(75) Inventor: Brian Ballard, Seattle, WA (US)

Correspondence Address: FITZPATRICK CELLA HARPER & SCINTO, 30 ROCKEFELLER PLAZA, NEW YORK, NY, 10112, US

(73) Assignee: MusicNet, Inc., New York, NY (US)

(21) Appl. No.: 11/394,998

(22) Filed: Mar. 31, 2006

(51) Int. Cl. G06F 3/048

(52) U.S. Cl. 715/783; 715/788

(57) ABSTRACT

A user interface for a list of items, and methods of creating and using the user interface. The user interface includes a first visible region that displays a visible list of multiple items, a second visible region that displays meta-information common to all items in the list, and a third visible region that displays a meta-control corresponding to an action applicable to all items in the list. The user interface permits user interaction with individual ones of the items in the first visible region, with individual interaction being performed separately and independently of action on other items in the list. In addition, the user interface permits user interaction with all items in the list at the same time, through viewing and comprehension of the meta-information in the second visible region, and through meta-control of all items in the list by performing the action corresponding to the meta-control in the third visible region on all items in the list.

### BACKGROUND OF THE INVENTION

1. Field of the Invention

The present invention relates to a graphical user interface and methods for creating and utilizing the graphical user interface, wherein the user interface includes meta-information and meta-control over all items in a list.

2. Description of the Related Art

Graphical user interfaces are available which arrange items of information into a list of items and display the list to the user for interaction therewith. Such user interfaces are sometimes referred to as “list controls” or “list view controls”. Most typically, these user interfaces arrange the items of information into multiple rows of column-arranged text and images, in which each column includes a title signifying the nature of the content in the column. In addition, such controls provide methods to control individual items in the list, such as by selection of the item in the list.

These conventional user interfaces provide a convenient interface by which large amounts of information can be arranged and displayed systematically, and which permit the user to interact with this information on an item-by-item basis.

Often, however, the displayed items of information share a common property. For instance, in one non-limiting example, the items might represent a collection of items resulting from a search. Heretofore, there has not been a graphical user interface that displays this common property as meta-information shared by all items in the list, and also allows meta-control over all items in the list.

### SUMMARY OF THE INVENTION

It is an object of the present invention to address the foregoing shortcomings found in conventional user interfaces, by providing a user interface that displays meta-information shared by all items in a list, and that allows meta-control over all items in the list.

In one aspect, the invention is a user interface for a list of items wherein the user interface comprises first, second and third visible regions. The first region comprises a visible display of the list of items, and the second region comprises a visible display of meta-information shared by all items in the list. The third region comprises a visible display of a meta-control for all items in the list, wherein the meta-control corresponds to an action applicable to all items in the list. User selection or activation of the meta-control is responded to by application of the action to all items in the list.

In one representative embodiment, for example, the items in the list are assembled from a search for items that share a common property. The meta-information is a display of the common property, and the meta-control is a download or a purchase of all items in the list, typically from a remote source over the Internet.

The user interface of the invention herein might form part of an overall display of supplemental user interface elements. In such a situation, the user interface might be provided with a fourth region which allows sliding control of the view window for the user interface so as to provide for a larger and a smaller view window for the user interface, with a corresponding smaller and larger display of the other supplemental user interface elements.

The invention also contemplates a method for creation and display of a user interface as described above, as well as use thereof by a user.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

FIG. 1 is a representative view of a first embodiment of a user interface according to the invention.

FIG. 2 is a representative view of a second embodiment of a user interface according to the invention.

### DETAILED DESCRIPTION OF THE PREFERRED EMBODIMENTS

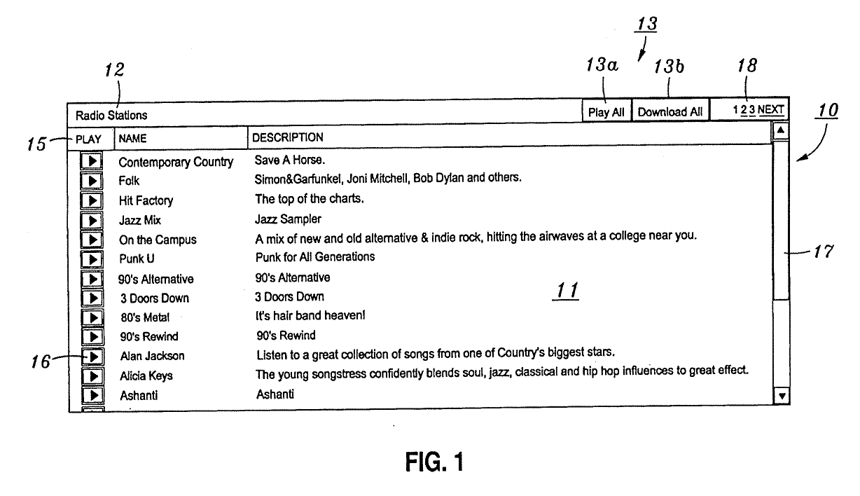

FIG. 1 shows a representative view of a user interface 10 according to a first embodiment of the invention. User interface 10 is a visible display on a computer monitor or the like, with which a user interacts using a pointing device such as a touch pad, mouse, keyboard or the like.

As shown in FIG. 1, user interface 10 includes a first region 11 comprising a list of items, a second region 12 which displays meta-information shared by, or common with, all items in the list, and a third region 13 for display of a meta-control corresponding to an action applicable to all items in the list. In the particular example of FIG. 1, all items in list 11 share a common property in that they are all radio stations, and thus second region 12 displays the meta-information in the form of the text “Radio Stations”. In this particular embodiment, there are two meta-controls 13a and 13b corresponding to actions that allow playing of all radio stations or downloading of all radio stations. Thus, meta-control 13a is labeled with text information “Play All”, and meta-control 13b is labeled with text information “Download All”. User selection of one or both of these meta-controls causes the corresponding action to be performed on all items in the list.

As further shown in FIG. 1, list 11 includes multiple rows of column-arranged information, with each column having a title region 15. The title includes textual information signifying the nature of the information contained in each column.

Individual items in list 11 may be selected by the user for individual action. For example, each item of information has a right-pointing triangular icon signifying a “Play” action for the selected item of information. By selecting the “Play” icon, the individual item may be played, and it is played individually and apart from other items in the list. For example, by selecting icon 16, the radio station named “Alan Jackson” is played separately and apart from other radio station items listed in list 11. Additional actions that can be performed on individual ones of the items in the list include methods to download individual items, methods to purchase individual items, and methods to display additional details of individual items.

Preferably, at least some of the actions that can be performed individually on items in the list can also be performed on all items in the list using the meta-controls. Here, for example, it is possible to play individual items in the list by selecting the items individually, and it is also possible to play all of the items in the list using meta-control 13a. It is not necessary for all actions performable individually on one item also to be performable by meta-control over all items. In this embodiment, for example, by selecting an item individually, it is possible to display additional details on the item. This action is not available in this embodiment for all items using meta-controls 13.

Situations sometime arise in which there are too many items for display in list 11. In such a case, a scroll bar 17 might be provided for scrolling display of items in the list. Additionally, the list of items might be split into a multi-page display of items, in which subsequent pages can be selected for display through the controls indicated generally at area 18. In these situations, even though all items might not be visible at the same time, the meta-information displayed at region 12 is still common to all items, even to non-visible items. On the other hand, with respect to the meta-controls at region 13, the meta-controls can be programmed to operate in one of two modes. In the first mode, the meta-controls are programmed to apply to all items, even to non-visible items. In the second mode, the meta-controls are programmed to apply only to visible items, and not to non-visible items. Where there are multiple meta-controls in region 13, it is possible for some of them to apply to all items (i.e., to visible and to non-visible items alike), and for others of them to apply only to visible items and not to non-visible items.

The user interface 10 might be displayed as part of a stand-alone application resident on a user's computer. Here, a “computer” can include electronic devices such as a personal computer, a mobile phone, a television set top box (“STB”), or other networked or non-networked electronic devices. The items assembled for display in list 11 might be items resident on the user's computer, or might also be items located remotely of the user's computer such as over a network or over the Internet. User interface 10 might also be provided as part of a display in a web browser; again, items displayed in list 10 might be resident on the user's computer, or might be located remotely over a network or the Internet.

Computer code to generate the display is computer-executable code that is resident on the user's computer. Alternatively, the computer code might be a plug-in such as an ActiveX® control, or it might be created by a script or platform-independent code (for example, Java) downloaded from a network or the Internet.

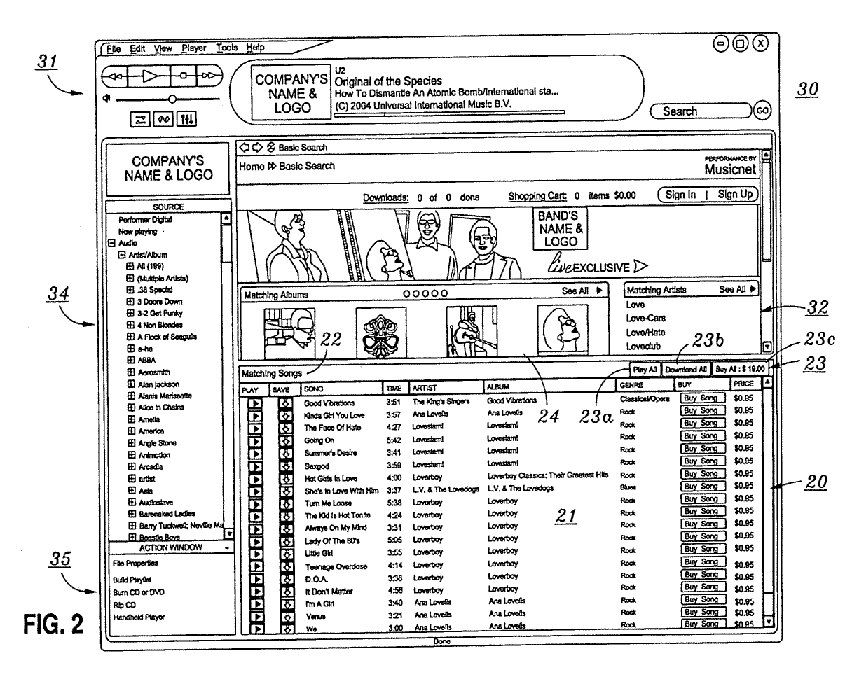

FIG. 2 is a view of a second embodiment of the invention in which user interface 20 according to the invention is incorporated as part of an overall display of supplemental user interface elements. In this case, user interface 20 is incorporated as part of a display 30 of a stand-alone program that has web components and which is displayed on a computer monitor or the like, and with which a user can interact using a touch screen, pointing device, keyboard, or the like. Display 30 includes supplemental user interface elements such as audio player 31, a web component 32, a tree-view control 34 which displays audio information in a hierarchical tree view, and an action window 35 with tools usable with audio files. Similar to the first embodiment, user interface 20 of the second embodiment includes a first region 21 having a list of items, a second region 22 for displaying meta-information shared by and common to all items displayed in list 21, and a third region 23 having meta-controls applicable to all items in the list. In the embodiment of FIG. 2, a search has been performed for audio files that match particular criteria. As a consequence, the meta-information that is shared by all items in the list is the fact that all items in the list match the search criteria. Display region 22 therefore displays meta-information in the form of text “Matching Songs”. Three meta-controls are displayed in region 23: a “Play All” meta-control 23a which upon user selection causes playback of all audio files found in the search; a “Download All” meta-control 23b which upon user selection causes all audio files to be downloaded; and a “Buy All” meta-control 23c which upon user selection causes purchase of all items in list 21. The cost for this selection is also indicated.

As before, each item in list 21 is selectable individually, and individual actions are performed on the selected items separately and apart from actions which might or might not be performed on any other item in the list.

One way in which the second embodiment of this FIG. 2 differs from the first embodiment is through the provision of fourth region 24 which permits re-sizing of the view window for user interface 20. Specifically, through user selection (such as by a click-and-drag operation), the user can change the size of the view window for user interface 20 so as to make it larger and smaller. In addition, through interaction with the other supplemental user interface elements on screen 30, as the size of the view window for user interface 20 is made smaller, other supplemental user interface elements are uncovered and become visible. Likewise, as the size of the view window for user interface 20 is made larger, other supplemental user interface elements in screen 30 become covered and can become no longer visible.

In most other respects, user interface 20 of this second embodiment is similar to that of the first embodiment, and additional description thereof is omitted in the interest of brevity.

The user interface of the present invention is created as follows. First, plural items for display are assembled, wherein each of the plural items shares at least one piece of meta-information that is common to all of the assembled items. The assembled items, or at least some of them, are displayed in a first region of the user interface, and the shared meta-information is displayed in a second region of the user interface. A meta-control is displayed in a third region of the user interface, wherein the meta-control corresponds to an action applicable to all of the assembled items.

In use, and responsive to user selection of the meta-control, the action corresponding to the meta-control is applied to all of the assembled items. It is not necessary for all of the assembled items to be displayed at the same time in the first region, but the meta-information displayed in the second region is common to all of the assembled items, even to non-visible items, and the meta-control displayed in the third region is applied to all of the assembled items, even to non-visible ones of the items.

The invention has been described with particular illustrative embodiments. It is to be understood that the invention is not limited to the above-described embodiments and that various changes and modifications may be made by those of ordinary skill in the art without departing from the spirit and scope of the invention.

1. A user interface which is displayable by a computer on a display screen thereof, and which enables user interaction by using a pointing device of the computer, wherein the user interface displays a list of items that share a common property and that are accessible by the computer, wherein the user interface comprises:
first, second and third visible regions displayed on the display screen and with which a user can interact by using the pointing device of the computer,
wherein the first region comprises a visible display of the list of items;
wherein the second region comprises a visible display of meta-information on the common property common to all items in the list; and
wherein the third region comprises a visible display of a meta-control corresponding to an action performable by the computer and applicable to all items in the list, and further comprises a visible display of a cost for carrying out such action.

2. A user interface according to claim 1, wherein the first region has methods to control individual items in the list.

3. A user interface according to claim 2, wherein the methods include methods selected from the group consisting of methods to select individual items in the list, methods to download individual items in the list, methods to play individual items in the list, methods to purchase individual items in the list, or methods to display additional details of individual items in the list.

4. A user interface according to claim 2, wherein at least one of the methods for individual items is the same as a meta-control action applicable to all items.

5. A user interface according to claim 1, wherein the first region further comprises a multi-page display including a visible page of visible items and at least one non-visible page of non-visible items, wherein the action corresponding to the meta-control applies to all items in all visible pages and to all items in all non-visible pages.

6. A user interface according to claim 1, wherein the first region further comprises a multi-page display including a visible page of visible items and at least one non-visible page of non-visible items, wherein the action corresponding to the meta-control applies only to all items in visible pages and not to any items in non-visible pages.

7. A user interface according to claim 1, wherein the meta-information of the second region comprises a display of text signifying the results of a search for items in accordance with user-inputted search criteria.

8. A user interface according to claim 1, wherein the action corresponding to the meta-control in the third region comprises an action selected from the group consisting of a download of all items in the list, a playback of all items in the list, or a purchase of all items in the list.

9. A user interface according to claim 1, further comprising a display of supplemental user interface elements, and wherein the user interface further comprises a fourth region for visible display of a sizing element responsive to user selection for re-sizing the view window of the user interface.

10. A user interface method for a list of items comprising:
assembling multiple items for display in a first region, each item sharing at least one piece of meta-information common to all of the assembled items;
displaying at least some of the assembled items in a first visible display region;
displaying the shared meta-information in a second visible display region;
displaying a meta-control in a third visible display region, wherein the meta-control corresponds to an action applicable to all of the assembled items;
displaying a cost for carrying out the action in the third display region; and
responding to user selection of the meta-control by applying the action to all assembled items.

11. A user interface method according to claim 10, further comprising the step of responding to user selection of individual items in the first region by executing methods to control individual items in the list.

12. A user interface method according to claim 11, wherein the methods include methods selected from the group consisting of methods to select individual items in the list, methods to download individual items in the list, methods to play individual items in the list, methods to purchase individual items in the list, or methods to display additional details of individual items in the list.

13. A user interface method according to claim 10, wherein at least one of the methods for individual items is the same as a meta-control action applicable to all items.

14. A user interface method according to claim 10, wherein the first region further comprises a multi-page display including a visible page of visible items and at least one non-visible page of non-visible items, wherein the action corresponding to the meta-control applies to all items in all visible pages and to all items in all non-visible pages.

15. A user interface method according to claim 10, wherein the first region further comprises a multi-page display including a visible page of visible items and at least one non-visible page of non-visible items, wherein the action corresponding to the meta-control applies only to all items in visible pages and not to any items in non-visible pages.

16. A user interface method according to claim 10, wherein the meta-information of the second region comprises a display of text signifying the results of a search for items in accordance with user-inputted search criteria.

17. A user interface method according to claim 10, wherein the action corresponding to the meta-control in the third region comprises an action selected from the group consisting of a download of all items in the list, a playback of all items in the list, or a purchase of all items in the list.

18. A user interface method according to claim 10, further comprising the step of displaying supplemental user interface elements, and displaying a sizing element in a fourth visible region which is responsive to user selection for re-sizing the view window of the user interface.

19. A user interface according to claim 1, wherein the cost displayed in the third region comprises a monetary price.

20. A user interface method according to claim 10, wherein the cost displayed in the third region comprises a monetary price.
